(19) United States
(12) Patent Application Publication
(10) Pub. No.: US 2010/0134306 A1
(43) Pub. Date: Jun. 3, 2010

(54) Ground Fault Circuit Interrupter With End-Of-Life Indicator

(75) Inventors: Cheng Zhi ZENG, Wenzhou (CN); Gui Chen, Wenzhou (CN)

Correspondence Address: HOGAN & HARTSON L.L.P., 1999 AVENUE OF THE STARS, SUITE 1400, LOS ANGELES, CA, 90067, US

(73) Assignee: Wenzhou Sansheng Electric Co., Ltd., Zhejiang (CN)

(21) Appl. No.: 12/468,038

(22) Filed: May 18, 2009

Related U.S. Application Data
(63) Continuation-in-part of application No. 11/449,991, filed on Jun. 9, 2006, now Pat. No. 7,535,371.

(51) Int. Cl. G08B 21/00; G09F 9/33

(52) U.S. Cl. 340/638; 340/815.45

(57) ABSTRACT

A circuit interrupter with end-of-life indicator is provided. A fuse is provided between the power supply and the control chip, and between the power supply and the main circuit. If the current passing through the control chip or the main circuit is drawing too much current, it indicates a short-circuit fault has occurred. In this case, the fuse is melted, and cutting off power supply to the control chip and the main circuit. An end-of-life indicator light turns off to signal to the user that an fault has occurred to the GFCI device.

This application is a continuation-in-part of U.S. patent application Ser. No. 11/449,991, filed Jun. 9, 2006, now U.S. Pat. No. 7,535,371, which application is incorporated herein by reference in its entirety.

### BACKGROUND

1. Field of the Invention

The present invention relates to a ground fault circuit interrupter. More specifically, the present invention relates to a ground fault circuit interrupter with an end-of-life indicator.

2. Description of the Related Art

With the increasing use of household electrical appliances, people demand that receptacles installed in their houses be capable of protecting them from serious injury when accidentally touched or other ground fault conditions occur. Thus, ground fault circuit interrupters (“GFCI devices”) are designed to break the electrical continuity upon detecting a ground fault condition occurring at an alternating current (“AC”) load.

Many electrical wiring devices including receptacles have a line side that is connectable to an electrical power supply, and a load side that is connectable to one or more loads and at least one conductive path between the line side and load side. When a person accidentally comes in contact with the line side of the AC load and an earth ground at the same time, a serious injury may occur because the human body forms another conductive path for the electrical current to flow through. There is a strong desire for electrical wiring devices that can break electric power supply to various loads such as household appliances and consumer electronic products when a ground fault condition occurs.

The GFCI devices can detect a ground fault condition and break the electric power supply by employing a sensing transformer to detect an imbalance between the currents flowing in the phase (also known as “hot”) and neutral conductive paths of the power supply. A ground fault condition happens when the current is diverted to the ground through another path such as a human body, that results in an imbalance between the currents flowing in the phase and neutral conductors. Upon detection of a ground fault condition, a breaker within the GFCI devices is immediately tripped to interrupt the electrical continuity and removes all power supply to the loads.

However, a GFCI device may reach the end of its life and cannot function properly to break the power supply after detecting a ground fault condition. Consumers are endangered if they are not aware that the GFCI device has reached the end of its life and continue to use it.

### SUMMARY OF THE PREFERRED EMBODIMENTS

A circuit interrupter with end-of-life protection has four components: 1) a control circuit to activate an electromagnetic unit upon detecting a predetermined condition; 2) a fuse coupled between the control circuit and the power supply; 3) an end life sensing circuit coupled to the control circuit; and 4) an end life indicating circuit coupled to the end life sensing circuit and the power supply. The end life sensing circuit includes a light emitting device and a light sensitive device controlled by the light emitting device. The end life indicating circuit includes a visual indicator to indicate that the circuit interrupter reaches the end of its life.

Another circuit interrupter with end-of-life protection has three components: 1) a control circuit to activate an electromagnetic unit upon detecting a predetermined condition; 2) a fuse coupled between the control circuit and the power supply; and 3) an end life sensing and indicating circuit coupled to the control circuit. The end life sensing and indicating circuit includes a light emitting device which is turned off to indicate that the circuit interrupter reaches the end of its life.

### BRIEF DESCRIPTION OF THE DRAWINGS

A more complete understanding of the present invention can be obtained by reference to the detailed description in conjunction with the accompanying drawings, which form part of the disclosure. These drawings depict only a typical embodiment of the invention and are not intended to limit its scope.

FIG. 1 is a circuit diagram of an exemplary embodiment of a circuit interrupter with end-of-life protection.

FIG. 2 is a circuit schematic of another exemplary embodiment of the circuit interrupter end-of-life protection.

### DETAILED DESCRIPTION OF THE PREFERRED EMBODIMENTS

To protect consumers, a circuit interrupter can indicate by visual means that the circuit interrupter reaches the end of its life. Alternatively, a circuit interrupter is tripped to disconnect a conduction path when the circuit interrupter reaches the end of its life. A circuit interrupter reaches the end of its life when some components are broken so that the circuit interrupter can not function properly to disconnect a conduction path after detecting a predetermined condition such as a ground fault. The indication of visual means and/or the trip condition can warn consumers to replace the circuit interrupter or not to use it.

The GFCI includes the following units based on functionality (the list is not exclusive, as the components may have more than one functions):

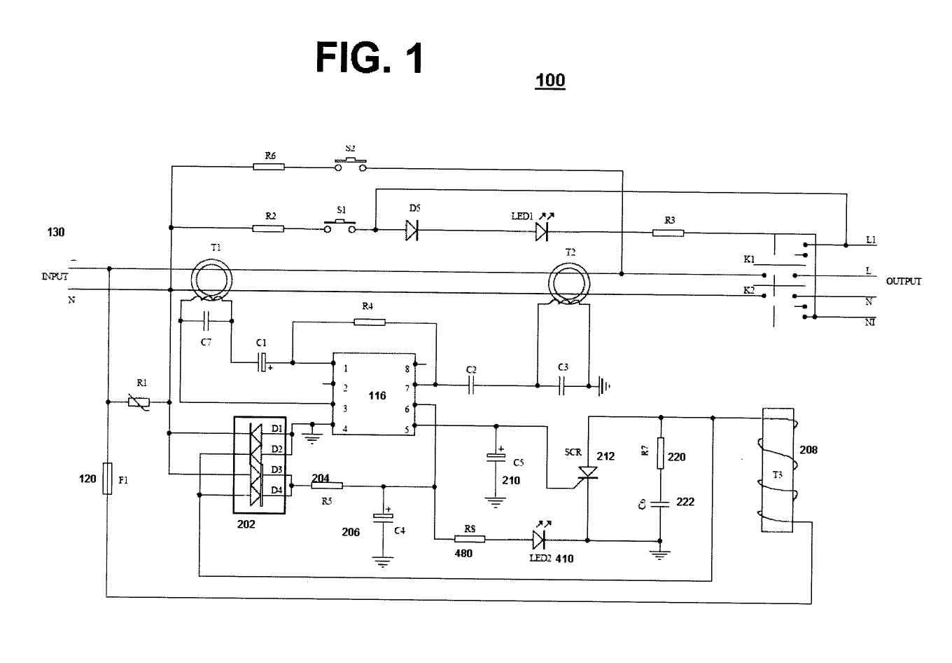

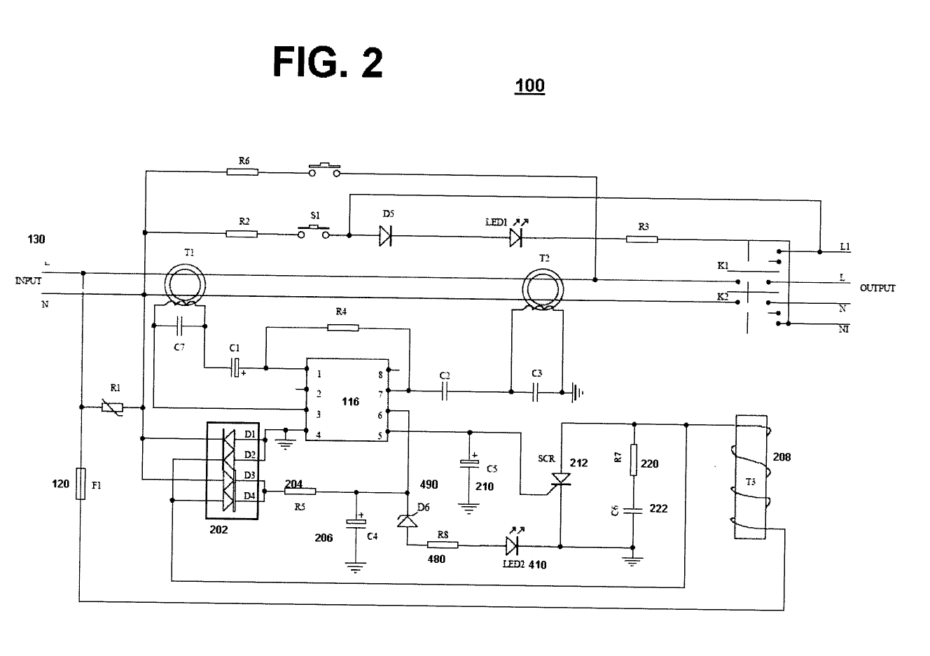

End-of-life indication circuit: R8, the end-of-life indicator light 410 (LED2 in FIGS. 1 and 2) and Zener diode 490 (D6 in FIG. 2).
Failure monitor circuit: F1, T3, and control chip 116.
Power source: Powers supply 130, bridge rectifier 202 (D1-D4), R5, C4, a first resistor 204 (R5), a first capacitor 206 (C4), the electromagnetic unit 208 (T3), and voltage stabilizing circuit inside the control chip 116.
Ground-fault detection circuit: Differential current sensing coils T1 and T2, and associated capacitors C1, C2, C3, and C7.
Signal amplified circuit: Amplifier internal to the control chip 116 and R4.
Trigger circuit: Circuit within the control chip 116 and C5.
Trip mechanism: The electromagnetic unit 208 (T3), silicon controlled rectifier 212 (SCR) and the mechanical trip apparatus (K1 and K2).
Test and reset circuit: R2, Switch S1, R6, and Switch S2.
Power indication circuit: D5, LED1, and R3.
Circuit protection unit: R1, R7, C6.

FIG. 1 illustrates an embodiment of the circuit interrupter 100. In this embodiment, the control chip 116 is an integrated circuit with a model number RV4145 manufactured by Fairchild Semiconductor. People with ordinary skill in the art understand that other chips and circuits such as LM1851, RV4141, KA2807 and KA2145 also can be used to implement the control chip 116. When a ground-fault is detected, the control chip 116 provides a signal to the trip circuit 118 to activate the electromagnetic unit 208 (T3) to disconnect the load from the power supply 130 (line L and line N).

The operations of a GFCI is generally known in the art. The device includes two portions: the trip mechanism and the ground-fault detection circuit. The trip mechanism includes the electromagnetic unit 208 (T3), silicon controlled rectifier 212 (SCR) and the mechanical trip apparatus. The ground-fault detection circuit includes current differential sensing coils T1 and T2, and the associated capacitors C1, C2, C3, and C7.

Under normal condition (no ground fault), the currents passing through the load line and neutral line of the power supply 130 are equal. In the case there is a ground fault, the currents would be different, and the sensing coils T1 and T2 sense the current differential and translate the difference into voltage. The signal amplifier circuit amplifies that voltage and provides it to the control chip 116. When the inputted voltage is above the threshold value, the control chip 116 issues a trigger signal (via pin 5) to the silicon controlled rectifier 212 and the trip mechanism. The trip mechanism then effects the mechanical trip apparatus (K1 and K2) to physically disconnect the power supply 130 from the loads.

The power supply 130 connects to the electromagnetic unit 208 (T3), silicon controlled rectifier 212 (SCR), and (when the trigger signal is issued by the control chip 116) to ground. When the control chip 116 issues a trigger signal at pin 5 to the silicon controlled rectifier 212 (SCR), current passes from the gate of the silicon controlled rectifier 212 (SCR), through the internal circuit (a resistor) of the control chip 116, to the ground pin (4). For ease of reference, that circuit is called the main circuit.

The GFCI device protects lives and property. However, the risk remains that the GFCI device may fail. The most common causes of failures of GFCI devices are improper installation and component failure after a period of use. Those faults may cause the GFCI device to fail to detect the ground-fault or cause the control chip 116 to fail to issue a trip signal. Sometime, the trip mechanism fails to trip properly. Such failures may lead to serious property loss, and even loss of life. Thus, the present embodiment includes an end-of-life indication circuit to alarm the user of the failures of the GFCI device, allowing to user to take remedial action.

The present embodiment includes a bridge rectifier 202 (D1-D4), a first resistor 204 (R5) and a first capacitor 206 (C4). The bridge rectifier 202 having diodes D1-D4 is coupled to the power supply 130 via the fuse 120 (F1) and the electromagnetic unit 208 (T3) to receive an alternating current (AC) voltage supply and to output a direct current (DC) voltage. The DC voltage passes through resistor 204, which limits the current flow, and is filtered by capacitor 206. The DC voltage is further stabilized by the stabilizing circuit internal to the control chip 116. Thus, the voltage at the voltage supply pin (pin 6) of the control chip 116 is stable. The current consumption of the control chip 116 is very small (on the level of μ Amps). In normal operation, the small current passes through the electromagnetic unit 208 (T3). But because the current (and the resulting magnetic field) is very small, the electromagnetic unit 208 does not trigger.

One output end of the bridge rectifier 202, the anodes of diodes D1 and D2, is connected to the ground and the ground pin (4) of the control chip 116. The other output end of the bridge rectifier 202, the cathodes of diodes D3 and D4, is connected to the first end of the first resistor 204 (R5). The second end of the first resistor 204 (R5) is connected to a positive end of the first capacitor 206 (C4) and the power supply pin (pin 6) of the control chip 116. The negative end of the first capacitor (C4) is connected to the ground.

One feature of the present invention allows for the monitoring of supply voltage to the control chip 116. Under normal operating condition, the voltage at the voltage supply pin (pin 6) of the control chip 116 is at 26 V, which turns on resistor 480 (R8) and the end-of-life indicator light 410 (LED2). In this embodiment, the end-of-life indicator light 410 (LED2) is a red light-emitting diode, and it being on indicates that the GFCI device is functioning properly.

A fuse 120 (F1) is disposed between the power supply and the main circuit and the control chip 116, and it monitors the total current flowing through the main circuit and the control chip 116. The melting point of the fuse 120 is selected such that during normal tripping and resetting of the GFCI, the fuse 120 does not melt. The fuse 120 melts when there is a short in the controller chip 116 or the main circuit. When the fuse 120 melts, no power is supplied to the mail circuit and the control chip 116. Thus, no power is supplied to the end-of-life indicator light 410 (LED2), and it turns off to signal to the user that an end-of-life failure has been detected. The user then can take the necessary steps, such as replacing the faulty GFCI, to remedy the problem.

In the case any of the fuse 120, electromagnetic unit 208 (T3), D4 of bridge rectifier 202, and the wiring forming the circuit experiences an open fault, the power supply to the control chip 116 and the end-of-life indicator light 410 would be 0. In this case, no current flows through the end-of-life indicator light 410, and the end-of-life indicator light 410 is off and signals to the user that an end-of-life failure has been detected.

Thus, in the present embodiment, the end of life of the electromagnetic unit 208 is detected.

In the case any of the current sensing coils T1 and T2 and R7 of the GFCI experiences short-circuit, the circuit interrupter 100 would trip and disconnect the load from the power source. The GFCI cannot be reset, signaling to the user of the end-of-life condition. Similarly, when the silicon controlled rectifier 212 (SCR) or the capacitor 222 experiences short-circuit, the current passing through the electromagnetic unit 208 (T3) is enough to cause the trip mechanism to enact and disconnects the load from the power supply 130. Under those conditions, the device again cannot be reset.

For the end-of-life indicator light 410, the high luminescence red light emitting diode is selected to reduced the energy consumption. The red LED operates on the order of a few hundred μ Amps. Moreover, resistor 400 (R8) also serves to limit the current flow through the end-of-life indicator light 410. The resistance value of R8 is set as high as the luminescence of the end-of-life indicator light 410 (LED2) would allow.

The second embodiment is illustrated in FIG. 2. In the second embodiment, a voltage-detecting element is disposed between the control chip 116 and end-of-life indicator light 410 to detect the voltage output of the control chip 116. The additional voltage-detecting element allows for more precise monitoring of the voltage supplied at pin 6 of the control chip 116 (pin 6 is Vₛ, power supply to the control chip). Here, the exemplary voltage-detecting element is a Zener diode 490 (D6) having a breakdown voltage of 13-15.6 V. The Zener diode 490 is disposed between pin 6 of the control chip 116 and end-of-life indicator light 410. When GFCI is functioning properly, pin 6 is supplied with a voltage greater than the breakdown voltage of 13-15.6 V of the Zener diode 490. In this case, the Zener diode 490 conducts current, and the end-of-life indicator light 410 (LED2) turns on and indicates that there is no end-of-life condition. On the other hand, when there's a end-of-life condition, the voltage supplied to pin 6 of the control chip 116 would fall below the breakdown voltage of 13-15.6 V. For example, as described previously, when the fuse F1 is blown, the voltage supplied to pin 6 of the control chip 116 is zero. In this case, the Zener diode 490 does not conduct, and the end-of-life indicator light 410 (LED2) is off and indicates to the user that there is an end-of-life condition.

The various component fails are indicated by the condition of the end-of-life indicator light 410 (LED2) and the circuit interrupter 100; they are summarized in the Table below:

| | | | The circuit |
|---|---|---|---|
| | | | interrupter |
| | | End-of-life Indicator | 100 in tripped |
| Component | Type of Fault | Light (LED 2) | condition |
| F1 | Open | Off | |
| T3 | Open | Off | |
| D1-D4 | Punch-through short | Off | |
| R5 | Short or open | Off | |
| C4 | Short | Off | |
| Control chip | Punch through short | Off | |
| SCR | Punch through short | | Tripped |
| LED2 | Open | Off | |
| R8 | Open | Off | |
| C6 | Punch through short | | Tripped |
| T1 | Short | | Tripped |
| T2 | Short | | Tripped |
| T3 | Short | Off | |

Although the invention has been described in terms of exemplary embodiments, it is not limited thereto. The described embodiments are to be considered in all respects only as illustrative and not as restrictive. People with ordinary skill in the art can appreciate using other electric components with similar electric characteristics. The term “connected to” can mean directly connected to or indirectly connected to. The present invention may be embodied in other specific forms without departing from its essential characteristics. The scope of the invention, therefore, is indicated by the appended claims rather than by the foregoing description. All changes, which come within the meaning and range of the equivalents of the claims, are to be embraced within their scope.

We claim:

1. A circuit interrupter comprising:
a control circuit to activate an electromagnetic unit upon detecting a predetermined condition;
a fuse coupled between the control circuit and a power supply, and coupled between an end life indicating circuit and the power supply.

2. The circuit interrupter of claim 1, wherein the visual indicator is a red color light emitting diode.
